(19) United States
(12) Patent Application Publication
(10) Pub. No.: US 2025/0085985 A1
(43) Pub. Date: Mar. 13, 2025

(54) METHOD AND APPARATUS FOR OPERATION RECORDING AND PLAYBACK

(71) Applicant: SAMSUNG ELECTRONICS CO., LTD., Suwon-si (KR)

(72) Inventors: Chen CHEN, Nanjing (CN); Wei ZHANG, Nanjing (CN)

(73) Assignee: SAMSUNG ELECTRONICS CO., LTD., Suwon-si (KR)

(21) Appl. No.: 18/768,840

(22) Filed: Jul. 10, 2024

Related U.S. Application Data
(63) Continuation of application No. PCT/KR2024/008543, filed on Jun. 20, 2024.

(30) Foreign Application Priority Data
Sep. 13, 2023 (CN) 202311182975.6

(51) Int. Cl. G06F 9/451

(52) U.S. Cl. CPC G06F 9/451

(57) ABSTRACT

A method for recording and playback including: recording an operation of a first device based on an operation recording instruction to obtain a user operation record; acquiring environment data of the first device; and performing user operations of the user operation record sequentially in a second device based on an operation playback instruction, where the performing the user operations of the user operation record includes, for one of the user operations: determining a corresponding target control in the second device based on the environment data of the first device and environment data of the second device, and performing a respective user operation based on the target control.

### CROSS-REFERENCE TO RELATED APPLICATION(S)

This application is a continuation application, claiming priority under § 365 (c), of an International application No. PCT/KR2024/008543, filed on Jun. 20, 2024, which is based on and claims the benefit of a China patent application number 202311182975.6, filed on Sep. 13, 2023, in the China Intellectual Property Office, the disclosure of which is incorporated by reference herein in its entirety.

### TECHNICAL FIELD

This disclosure relates to computer application technologies, and particularly to a method and apparatus for operation recording and playback.

### BACKGROUND ART

With the development of mobile Internet, digital terminal devices have gradually become the main tools for information dissemination, socialization, digital office, and shopping in people's work and life. In some scenes, users often need to continuously do a large number of repetitive operations on an application (“APP”). For example, company staff fill in a large number of registration forms on an App client every day, submit promotional articles about related products in major App forums, individual users may need to perform relevant App functions regularly, and the like. These matters, both in work and in life, may contain tedious repetitive work. In order to improve the operational efficiency of such repetitive work and to reduce the manual overhead, it may be considered to record these operations to automatically trigger respective user operations based on a recorded operation script, instead of manual operations. However, existing solutions for operation recording and playback are often proposed for test scenes, and such solutions may not be suitable for the user operations with respect to an APP on a digital terminal device. A few of the reasons are analyzed as follows:

In practical application, scripts under different system platforms may not be executed across platforms due to the differences in system platforms. Thus, for a certainAPP, in order to apply to different system platforms, scripts may need to be developed and maintained for the different system platforms. Accordingly, the location, layout, and attributes of controls in the APP may be different due to different systems. For example, for a certain APP, it may be necessary to develop respective running scripts for an Android system and an Apple system, so as to be suitable for devices installed with different systems. In addition, different screen sizes and resolutions of different devices may also cause the control of the same APP to have different locations on different devices.

Since the existing solutions for operation recording and playback are generally proposed for script test scenes and do not have the capability of playing back the recorded operation across devices and platforms, when adopting the existing solutions for operation recording and playback, it may cause the failure of control positioning during operation playback due to the change of control location and layout, thus resulting in the recorded operation not being correctly performed during the playback. Therefore, the above-mentioned existing solutions may not be suitable for recording and playback of user operations with respect to an APP on the digital terminal device.

### DISCLOSURE

### Technical Solution

In view of the above, provided is a method and apparatus for operation recording and playback, which is suitable for recording and playback of user operations with respect to an APP on a digital terminal device.

Additional aspects will be set forth in part in the description which follows and, in part, will be apparent from the description, or may be learned by practice of the presented embodiments.

According to an aspect of the disclosure, a method for recording and playback may include: recording an operation of a first device based on an operation recording instruction to obtain a user operation record; acquiring environment data of the first device; and performing user operations of the user operation record sequentially in a second device based on an operation playback instruction, where the performing the user operations of the user operation record includes, for one of the user operations: determining a corresponding target control in the second device based on the environment data of the first device and environment data of the second device, and performing a respective user operation based on the target control.

The environmental data may include: device-related data, application-related data, user-related data, or user operation-related data, and the user operation-related data may include: a page screenshot, an XML layout file of a page, or a control screenshot of an operation object control.

The determining the corresponding target control in the second device based on the environment data of the first device and the environment data of the second device may include: extracting positioning feature data corresponding to an operation based on the environment data of the first device; obtaining a prediction value of one or more positioning methods according to a positioning method prediction model based on the positioning feature data; determining a candidate positioning method among the one or more positioning methods for positioning the target control in the second device according to the prediction value; and determining the target control in the second device based on the candidate positioning method and the environment data of the first device.

The positioning feature data may include data based on: whether a login user corresponding to the operation recording instruction and a login user corresponding to the operation playback instruction are the same, whether a device corresponding to the operation recording instruction and a device corresponding to the operation playback instruction are the same, whether an operating platform of the device corresponding to the operation recording instruction and an operating platform of the device corresponding to the operation playback instruction are the same, whether an application corresponding to the operation recording instruction and an application corresponding to the operation playback instruction are the same, whether a resource identification attribute of the target control is included in the environment data of the first device and the environment data of the second device, an XPath path positioning step number of the target control in the environment data of the first device, whether the target control has a different text string in the first device and the second device, a text string attribute length of the target control in the first device, an index value of a control type of the target control in the first device, an interface content similarity between the first device and the second device, a page similarity between the first device and the second device, or an interface style similarity between the first device and the second device.

The one or more positioning methods may include: a control attribute-based positioning method, or an interface matching method, where the interface matching method includes: an image matching positioning method or a layout matching positioning method.

The determining the candidate positioning method may include: screening out a positioning method based on the prediction value being greater than a pre-set threshold value from the one or more positioning methods to obtain the candidate positioning method; or ordering the one or more positioning methods in an order based on respective prediction values, and selecting a number of positioning methods from the order as the candidate positioning method, wherein the number of positioning methods is a pre-set number of candidate positioning methods.

The determining the target control in the second device based on the candidate positioning method and the environment data of the first device may include: traversing the candidate positioning method according to an order of respective prediction values; and determining the target control of a current operation according to the candidate positioning method based on the environment data of the first device until the target control is determined or the traversing is completed.

According to an aspect of the disclosure, an electronic device including a processor and a memory, the memory storing an application program executable by the processor for causing the processor to perform: recording an operation of a first device based on an operation recording instruction to obtain a user operation record; acquiring environment data of the first device; and performing user operations of the user operation record sequentially in a second device based on an operation playback instruction, where the performing the user operations of the user operation record includes, for one of the user operations: determining a corresponding target control in the second device based on the environment data of the first device and environment data of the second device, and performing a respective user operation based on the target control.

The environmental data may include: device-related data, application-related data, user-related data, or user operation-related data, and the user operation-related data may include: a page screenshot, an XML layout file of a page, or a control screenshot of an operation object control.

The positioning feature data may include data based on: whether a login user corresponding to the operation recording instruction and a login user corresponding to the operation playback instruction are the same, whether a device corresponding to the operation recording instruction and a device corresponding to the operation playback instruction are the same, whether an operating platform of the device corresponding to the operation recording instruction and an operating platform of the device corresponding to the operation playback instruction are the same, whether an application corresponding to the operation recording instruction and an application corresponding to the operation playback instruction are the same, whether a resource identification attribute of the target control is included in the environment data of the first device and the environment data of the second device, an XPath path positioning step number of the target control in the environment data of the first device, whether the target control has a different text string in the first device and the second device, a text string attribute length of the target control in the first device, an index value of a control type of the target control in the first device, an interface content similarity between the first device and the second device, a page similarity between the first device and the second device, or an interface style similarity between the first device and the second device.

The one or more positioning methods may include: a control attribute-based positioning method or an interface matching method, where the interface matching method includes: an image matching positioning method or a layout matching positioning method.

The determining the candidate positioning method may include: screening out a positioning method based on the prediction value being greater than a pre-set threshold value from the one or more positioning methods to obtain the candidate positioning method; or ordering the one or more positioning methods in an order based on respective prediction values, and selecting a number of positioning methods from the order as the candidate positioning method, wherein the number of positioning methods is a pre-set number of candidate positioning methods.

The determining the target control in the second device based on the candidate positioning method and the environment data of the first device may include: traversing the candidate positioning method according to an order of respective prediction values; and determining the target control of a current operation according to the candidate positioning method based on the environment data of the first device until the target control is determined or the traversing is completed.

According to an aspect of the disclosure, a non-transitory machine-readable medium including instructions that when executed may cause at least one processor of an electronic device to: record an operation of a first device based on an operation recording instruction to obtain a user operation record; acquire environment data of the first device; and perform user operations of the user operation record sequentially in a second device based on an operation playback instruction, where performing the user operations includes, for one of the user operations: determining a corresponding target control in the second device based on the environment data of the first device and environment data of the second device, and performing a respective user operation based on the target control.

### DESCRIPTION OF DRAWINGS

The above and other aspects, features, and advantages of certain embodiments of the present disclosure will be more apparent from the following description taken in conjunction with the accompanying drawings, in which:

FIG. 1 is a schematic flow diagram of a method according to an embodiment of the disclosure;

FIG. 2 is a flowchart of a training method of a positioning method prediction model according to an embodiment of the disclosure;

FIG. 3 is a schematic flow diagram of an image matching positioning algorithm according to an embodiment of the disclosure;

FIG. 4 is a schematic flow diagram of a layout matching algorithm according to an embodiment of the disclosure;

FIG. 5 is an exemplary diagram of scene 1 according to an embodiment of the disclosure;

FIG. 6 is an exemplary diagram of scene 2 according to an embodiment of the disclosure;

FIG. 7 is an exemplary diagram of scene 3 according to an embodiment of the disclosure; and

FIG. 8 is a schematic structural diagram of an apparatus according to an embodiment of the present invention.

### MODE FOR INVENTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

It will be understood that when the terms “has,” “includes,” “comprises,” “having,” “including,” and “comprising,” when used in this specification, specify the presence of stated features, figures, steps, operations, components, members, or combinations thereof, but do not preclude the presence or addition of one or more other features, figures, steps, operations, components, members, or combinations thereof.

The term “or” includes any and all combinations of one or more of a plurality of associated listed items.

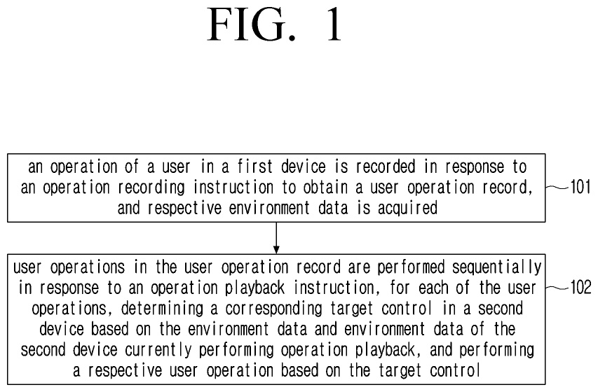

FIG. 1 is a schematic flow diagram of a method for operation recording and playback according to an embodiment. As shown in FIG. 1, the embodiment may include the following steps.

Step 101: an operation of a user in a first device may be recorded in response to an operation recording instruction to obtain a user operation record, and respective environment data may be acquired.

This step may be used for operation recording. Different from the existing solutions, in order to perform correct operation playback across devices and platforms subsequently, the environment data may be acquired at the same time such that when operation playback is performed, based on the environment data during recording and playback, a target control in the recorded step may be accurately positioned in a device in which the playback is performed, and may thereby avoid the problem of incorrect positioning of the control caused across devices and platforms, and ensure that the recorded APP operation can be accurately played back.

Further, in order to improve the flexibility of the user's playback operation, a user may revise the recorded user operation record and delete one or more steps as needed.

According to an embodiment, the environment data may include:
device-related data, application-related data, user-related data, and/or each user operation-related data.

The device-related data may include any combination of device product category (such as mobile devices, intelligent household appliances, wearable devices), brand, device model, device system platform and version, device screen resolution, screen pixel density (DPI density), and other information.

The application-related data may include any combination of application name, application version number, version update date, mobile application type (such as web, native, hybrid), application complexity level, application category, and other information.

The user-related data may include: whether the user logs in, user account information, and other information.

The user operation-related data may include any combination of a page screenshot, an XML layout file of a page, and/or a control screenshot of an operation object control. The page screenshot may be used for performing page control layout matching through image segmentation, contour recognition, and other image processing when positioning the target control. An icon screenshot may be used for performing image matching when positioning the target control to determine a target control of an operation by comparing and mapping a target control of a required operation in a playback page. The XML layout file may include control attributes. The control attributes may vary according to the platforms. Taking the Android system as an example, the attributes may include resource id, class, text, index, and xpath, and also may include state attributes and action attributes of operated controls.

According to an embodiment, the user operation record may include a record name, an operation device, the number of operation steps, and an operation flow such as {application 1: {operation 1, operation 2, operation 3}, application 2: {operation 4, operation 5, operation 6, operation 7} . . . }. For historical data related to each step recorded by recording the operation, the user operation record may further include an operation number of each step, an action, a file data storage path, which may include storage locations of files such as a page layout XML and a page screenshot, and historical data related to a control object, which may include control attributes: {attribute 1, attribute 2, attribute 3 . . . }, a control screenshot storage path, layout information, etc.

Device information collection may be performed using tools such as Appium, uiautomator, and UIAutomation or tools with secondary development similar to their principles. Application information extraction may be performed by reading application configuration files or using application parsing tools. Operation flow extraction and recording may be performed using tools based on automation framework principles.

Step 102: this step may include performing user operations in the user operation record sequentially in response to an operation playback instruction, and for each of the user operations, determining a corresponding target control in a second device based on the environment data and environment data of the second device currently performing operation playback, and performing a respective user operation based on the target control.

In this step, the script of each operation in the user operation record may be parsed to obtain a manipulation command executable by the device, and a playback device may perform a respective operation on the target control based on the parsed operation command, so as to realize automatic playback of the recorded operation.

Here, different from the existing solutions, the process of performing operation playback may determine a corresponding operation object control (namely, the target control) of each recorded operation in the playback device in combination with the environment data acquired during operation recording and the environment data acquired during operation playback, so as to realize the cross-device and cross-platform playback of recorded APP operations.

According to an embodiment, for steps of the user operation in the user operation record, the following steps a1-a4 may be adopted. A corresponding target control in a second device may be determined based on the environment data obtained during operation recording and based on environment data obtained from the second device currently performing operation playback.

Step a1: positioning feature data corresponding to a current operation step may be extracted based on the environment data.

This step may extract the positioning feature data from the environment data during operation recording and playback, so as to predict a candidate control positioning method which may be adopted based on the feature data to ensure that the target control operated by the current user is accurately positioned during operation playback.

One may set suitable positioning feature data according to the needs of practical application.

According to an embodiment, the following method may be adopted to extract the positioning feature data from the environment data.

Firstly, data pre-processing may be performed on the environment data acquired during operation recording and playback, including deleting null values and outliers, encoding category variables, and other pre-processing operations. The method is known to a person skilled in the art and will not be described in detail herein.

Then, feature engineering may be performed on preprocessed feature items, characteristics may be deleted, such as those found to be redundant or irrelevant, and better features may be constructed to describe the data.

In this step, feature selection may be performed based on the pre-processed data to reduce data dimensions and improve the accuracy of a model. The existing method may be adopted to implement this step. For instance, feature selection methods such as variance selection, chi-square test, mutual information, and Pearson correlation coefficient may be selected. Tools such as sklearn in Python may be used for feature selection, and features of data may described through manual selection according to engineering experience.

According to an embodiment, the following priority strategies may be summarized to select suitable feature items for feature engineering.

### 1. Priority Strategy for Feature Selection Based on Control Attributes:

(1) A control element may have a Resource-Id attribute, and expressions for which Resource-Id has uniqueness may have a highest priority.

In an XML layout file of an Android interface, the Resource-Id attribute possessed by the control element may have uniqueness in most cases. The control element may be positioned efficiently and uniquely based on this attribute, and the expression may be short with high readability. Therefore, if the control element possesses the Resource-Id attribute and the Resource-Id has uniqueness, whether the Resource-Id exists may be taken as the selected feature item.

(2) XPath path expressions may have fewer positioning steps.

Whether an absolute path expression or a relative path expression, the XPath path expression may traverse a tree structure layer by layer through multiple positioning steps. If the number of positioning steps is too large and a length of the path expression is too long, the positioning efficiency of a target control element may be greatly reduced. At the same time, too many positioning steps of the XPath path expression may be overly dependent on an XML layout structure. If a type of a control element of an ancestor node in the middle changes, it may cause the entire XPath path expression to be positioned incorrectly. Therefore, alternatively, whether there is unique text,-text and the number of addressing steps calculated using the expression slash “/” may be taken as the selected feature items.

(3) A text string attribute of the control element may be of moderate length.

The shorter the text information is, the clearer the semantics of the text are, and the more stable the positioning method using the text information may be. If the text information is too long, a probability of error may increase when using the text to position, and a probability of changing of the control element text information may also increase. When using the text to position, the length may be about 5 Chinese characters, and the text positioning effect may be improved. Therefore, the number of words in text string may be taken as the selected feature items.

(4) The control type of the control element may be indexed ahead among other control elements of the same type.

When using the type of the control element to position, if the XML layout file is complex, there may be many controls of the same type for the target element, and the target control element may be indexed backward, which may lead to a decrease in searching efficiency. If the control elements of the same type of parent nodes change, the stability of the method may decrease. Therefore, an index value (namely, a class-index quantity value) of the type of the control to which the target control belongs may be taken as the selected feature item.

### 2. When the Same Version is Applied to the Same Application, the Inconsistency in Interface Performance may Include: Inconsistency in Style and Content (Data).

(1) Inconsistency in style:

Inconsistency in style may provide and support different resolutions when developing applications, which may require development adaptation of different layouts and styles. Each mobile phone developer may re-modify and define native user interface (UI) components provided by the system according to their product needs, which may lead to inconsistent performance of the same program using the same system UI among different mobile phone manufacturers. For the purpose of localization and internationalization, enterprise developers may automatically switch display languages and UI colors according to different regions. Features that affect style consistency may include device product category (such as mobile devices, intelligent household appliances, wearable devices), brand, device model, device system platform and version, device screen resolution, DPI density, etc.

(2) Inconsistency in data content:

The background operation of the application may dynamically switch the content to be displayed (homepage pictures, advertisements, and information flows of news media applications). Inconsistencies in data caused by a user may include the application being restricted by a mobile phone security manager, which may result in various types of insufficiencies with rights and abnormal display information (e.g., network access rights, geographic location acquisition rights, etc.). Inconsistencies in data may further include personalized recommendations made after logging into a user account or based on recognized user identity and user habits according to historical cookies. Features that affect data consistency may include whether the user logs in, whether it is the same user account, control type, etc.

Therefore, according to the above division of description and hidden information, feature combinations may be made on relevant feature sets to form new features or feature sets to extract more and richer information. Data may be better described by the interaction between multiple features through feature combination, which is a product feature combination. These features may be combined into new features such as style similarity and content similarity. Page similarity may also be obtained using an interface similarity comparison algorithm, such as comparing fingerprints of two pictures based on a perceptual hash algorithm, judging whether two pictures before and after an operation are transformed, and performing a respective operation through an obtained similarity value.

According to an embodiment, the positioning feature data described in step a1 may include any combination of the following data regarding:
whether login users corresponding to the operation recording and playback are the same, whether the operation recording and playback crosses devices, whether the operation recording and playback crosses platforms, whether application versions corresponding to the operation recording and playback are consistent, whether resource identification attributes of the target control exist in the environment data of the first device and the second device, an XPath path positioning step number of the target control in the environment data of the first device, whether the target control has unique (e.g. different) text string in the first device and the second device, a text attribute length of the target control in the first device, an index value of a control type to which the target control belongs in the first device, an interface content similarity between the first device and the second device, a page similarity between the first device and the second device, and/or an interface style similarity between the first device and the second device.

Step a2: a prediction value of each pre-set positioning method may be obtained using a pre-trained positioning method prediction model based on the positioning feature data.

According to an embodiment, in order to determine an optimal positioning way of a playback target control, the above-mentioned positioning method prediction model may be implemented by adopting an extreme gradient boosting (XGBoost) machine learning algorithm. XGBoost may provide fast calculation speed, good model performance, and strong generalization ability. In an initial model training, a base learner may be first trained from an initial training set, and then the training sample distribution may be adjusted according to the performance of the base learner such that the training samples which were wrong by the previous base learner are paid more attention later, and then a next base learner may be trained based on the adjusted sample distribution. This process may be repeated until the number of base learners reaches a pre-specified value m, and finally, these m base learners may be weighted together.

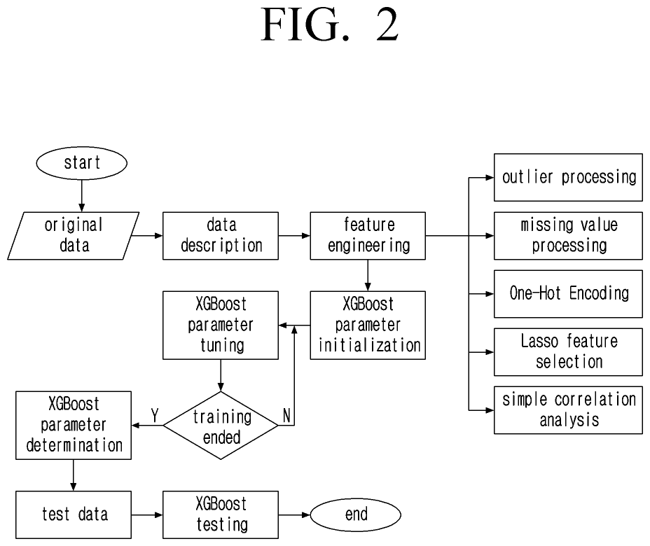

FIG. 2 shows a flowchart of a training method of the above-mentioned positioning method prediction model. As shown in FIG. 2, firstly, data sets may be collected and prepared for training, including selecting appropriate features, processing missing values, performing feature engineering, etc. Ensuring the quality and accuracy of the data sets is important for training results. Next, the data sets may be divided into a training set and a validation set. The training set may be used for training the model and the validation set may be used for evaluating the performance of the model. An over-fitting phenomenon may be effectively avoided by correctly dividing the training set and the validation set. Then, appropriate hyperparameters may be selected for model training. XGboost may include many adjustable hyperparameters, such as learning rate, number of trees, maximum depth, etc. By adjusting these hyperparameters, the performance of the model may be optimized. XGboost is an ensemble learning-based method that gradually improves the performance of the model by building multiple weak classifiers (decision trees). During training, each subtree may be adjusted based on results of a previous tree to minimize a loss function. During training, a gradient lifting algorithm may be used for iterative optimization. Each iteration step may calculate the gradient and loss function of the training samples and adjust the weight of the tree to minimize the loss. After completing the training, the performance of the model may be evaluated using the validation set. Indicators such as the accuracy, recall rate, and F1 score of the model may be calculated to judge whether the model meets the requirements. If the performance is poor, attempts may be made to adjust the hyperparameters or perform more feature engineering.

A prediction result outputted by the positioning method prediction model may be a specific positioning method or may be a prediction probability of each pre-set positioning method, namely, a prediction classification problem is treated as a multi-classification problem. The user may specify what data to output by setting input parameters of the XGboost.

According to an embodiment, the positioning method may include a control attribute-based positioning method and/or an interface matching method.

The control attribute-based positioning method may be positioning based on one control attribute or a combination of several control attributes. For example, taking the Android system as an example, positioning may be based on Resource_id and class of the control, based on text string and class of the control, based on class and index of the control, based on an absolute Xpath attribute of the control, based on a coordinate range of the control, based on a content-desc attribute of the control, etc. but is not limited to the above.

According to an embodiment, considering that the expression of text attributes of the same control may be inconsistent in different versions of applications, for example, appl may have two functional controls on the home page, and the text attributes of the two controls on A user device may be “free to take fruits” and “movie/show”, while corresponding text attributes on B user device are “free fruits” and “see movie show”. In this case, semantic matching may be adopted to achieve control positioning. Firstly, special symbols in the text may be processed, and then the text matching may be performed by adopting a semantic similarity algorithm, such as text matching algorithms such as cosine similarity calculation, edit distance (Levenshtein distance), and a word2vec algorithm may be adopted, which will not be described in detail herein.

The interface matching method may include an image matching positioning method and a layout matching positioning method.

The image matching positioning may refer to matching the location of the target control on the page by adopting an image feature matching algorithm based on an “operation control screenshot” of each step recorded during operation recording and a “current page screenshot” of a respective step during playback. The image feature matching algorithm may take the target image and an image to be matched as inputs and take a coordinate value of a region vertex matched on the image to be matched as an output result. According to an embodiment, a SIFT feature matching algorithm, an OCR technology, and other image processing technologies may be used. The positioning method may have high processing efficiency, quickly complete the processing from image input to coordinate positioning, and ensure that the playback process may be completed smoothly.

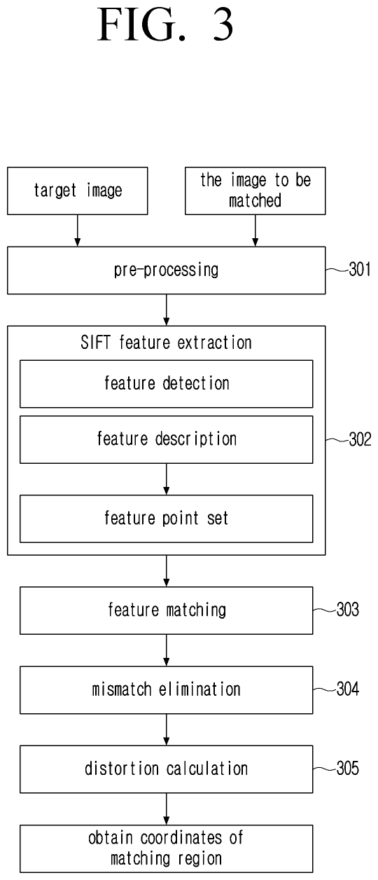

FIG. 3 is a schematic flow diagram of an image matching positioning algorithm. As shown in FIG. 3, the image matching positioning algorithm may include five steps: pre-processing, feature extraction, feature matching, eliminating mismatch, and calculating distortion. The process is as follows.

An input of the image matching positioning algorithm may include the target image and the image to be matched. The target image may refer to a screenshot in which location coordinate information of a matching region is to be acquired in operating a current page screenshot of the playback device. The image to be matched may refer to an operation control screenshot recorded during a recording operation process.

Pre-processing performed in step 301 may include processing the image to optimize the subsequent feature extraction and matching steps. The processing may further include image denoising, image enhancement, size standardization, color space conversion, grayscale transformation processing, etc. Pre-processing may improve the image quality and reduce interference factors, such as to improve the accuracy and robustness of subsequent steps.

In step 302, feature extraction may be performed using the SIFT feature matching algorithm. This step may include image feature detection, an image feature descriptor, and obtaining a feature point set. The feature extraction step may extract feature points or feature descriptors with uniqueness and distinguishing ability from images. In the SIFT feature matching algorithm, key points in the image may be extracted by extrema detection of scale space and the key point positioning, and then the feature descriptor may be calculated for each key point. The SIFT method in OpenCV may be used to acquire a corresponding feature point set and description subset based on the target image and the image to be matched respectively for subsequent feature matching.

In step 303, feature matching may be performed, and features extracted from an image to be searched may be matched with features in training data. The SIFT feature matching algorithm may use a distance measure (such as Euclidean distance or Hamming distance) to calculate the similarity between two feature descriptors. The feature matching may find a feature from the image to be searched that is most similar to a respective feature in the training data.

In step 304, a mismatch elimination operation may be performed for a false match or mismatch problem that may exist in step 303. A method for eliminating mismatches may adopt some screening rules, for example, by setting a threshold value or adopting a consistency test, etc. to screen the most reliable set of matches in a matching result.

In step 305, a distortion correction may be included for the rotation, scaling, etc. existing between the image to be matched and a training data image. The distortion correction may be realized through image registration or transformation correction. A homography matrix between the two may be calculated, and finally, perspective transformation may be performed on the target image. The distortion correction step may spatially align the image to be searched with the training data image, so as to more accurately position the location of the target control.

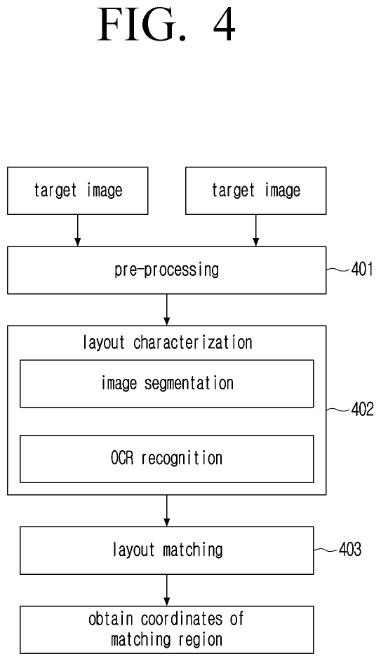

A method for layout matching positioning may include the following. The page screenshot image obtained in the recording process may be characterized by adopting image segmentation, contour recognition, and other technologies, and location coordinate information of a manipulation control in the current page layout may be acquired. At the same time, a layout characterization operation with the same flow may be performed on the current page screenshot of the playback device, and the control may be positioned through layout matching and positioning coordinate information. FIG. 4 shows a schematic flow diagram of a layout matching algorithm. An input of the algorithm may include the target image and the image to be matched. The target image may refer to the current page screenshot of the playback device, and the image to be matched may refer to the operation page screenshot recorded during an operation recording process. As shown in FIG. 4, the implementation process of the layout matching algorithm may include the following.

Step 401 is a pre-processing stage in which the input image may be subjected to grayscale transformation processing. Since information such as the color of the image in the subsequent process may not be taken as a processing attribute, converting the image into a grayscale image may improve the image quality and increase the clarity and contrast of the image so that better effects may be obtained in the subsequent processing.

Step 402 is a layout characterization stage that may include segmenting an acquired page screenshot image. Through image segmentation technology, each control and element in the page screenshot image may be separated into independent image blocks. The layout characterization stage may further include edge detection, dilation, and contour recognition. The edge detection may find an edge contour of the object by detecting large changes in color, brightness, and other places in the image through the algorithm. The dilation operation may enlarge or dilate pixels in the image, making the object larger, and may be used for filling in small breakpoints, connecting small edges, etc. A contour detection may be based on the edge detection, which may detect contour bars of the image and convert them into a contour list. For each segmented image block, the OCR part may implement the segmentation of image word, line, and block with three precisions through a Tesseract-OCR engine. Borders whose length or width are too small or too long, which do not meet the real scene in the application, may be eliminated by defined rules.

Through image segmentation and OCR recognition, a contour set which fits with the page control may be extracted. Considering that the set may have redundancy, in order to further improve the accuracy of layout characterization, the obtained set may be further screened by some pre-set rules according to engineering experience and experimental summary. For example, for the functional control, a contour whose length and width are less than a certain threshold value may be cleared, and a threshold value of the contour may be set according to a screen width of the current device. At the same time, contours inside contours of a non-outer frame may be screened. In this way, by adding the screening of the contours, the validity of the contours may be guaranteed, the number of contours may be reduced, and the consistency of layout characterization may increase when processing the same application pictures of different devices.

In step 403, for the screened contours, the contours may be layered from top to bottom, and the contours of the same layer may be numbered from left to right. By recording a layout number of a recording interface control, contours of the same number may be searched in the page layout of the playback device, the control may be positioned, and coordinates of the center of the contours may be returned.

Step a3, a candidate positioning method for positioning the target control in the second device may be determined according to a pre-set screening strategy based on the prediction value.

This step may determine a candidate positioning method for positioning the target control of the current playback step based on a prediction result of step a2.

A user may set a suitable screening strategy according to actual needs.

According to an embodiment, the screening strategy may include: screening out a positioning method of which the prediction value is greater than a pre-set threshold value from the pre-set positioning methods to obtain the candidate positioning method.

According to an embodiment, the screening strategy may also include: ordering the pre-set positioning methods according to a descending order of the prediction values, and selecting the first N positioning methods from an ordering result as the candidate positioning methods, the N being a pre-set number of the candidate positioning methods, and N being greater than or equal to 1.

Step a4, the target control may be determined in the second device based on the candidate positioning method and the environment data.

According to an embodiment, the step that the target control is determined in the second device based on the candidate positioning method and the environment data may include:
traversing the candidate positioning method according to a descending order of the prediction values, and determining the target control of a current operation using the candidate positioning method based on the environment data until the target control is successfully determined or the traversing is completed.

In this step, the target controls may be positioned by successively selecting candidate positioning methods according to an order of a pre-set probability value from high to low. If the positioning fails, namely, the positioning of the target control cannot be normally acquired, a next candidate positioning method with high predicted probability may be adopted, so as to improve the success rate of positioning.

According to an embodiment, a method may perform operation playback based on the environment data during operation recording and playback and may ensure that the target control operated in each step is accurately positioned during the operation playback, so as to avoid the problem of failure of control positioning caused by cross-device and cross-platform playback. Therefore, for the method may allow for recording and playback of user operations with respect to an APP on the digital terminal device.

The device for operation recording and playback may be a mobile terminal (such as a mobile phone), a wearable device (such as a smart watch, a smart bracelet, smart glasses, a head-mounted display (HMD), etc.), an intelligent household appliance (such as a refrigerator, a television, etc.), a tablet computer, a desktop computer, a laptop computer, a handheld computer, a notebook computer, a netbook, a personal digital assistant (PDA), an augmented reality (AR)/virtual reality (VR) and other devices equipped with intelligent systems, or a device containing a graphical user interface. Platforms of the device may include and are not limited to currently mainstream intelligent operating platforms (such as Android/IOS/Tizen, etc.). Furthermore, a recording device and the playback device may access through a wireless cellular communication network (4G, 5G network), a Wi-Fi network, etc. and connect through a debug port of a system bridging tool (such as ADB, WDA, SDB, etc.), or realize unified management of different devices by encapsulating tools such as android debug bridge (ADB) and web driver agent (WDA). An automatic operation may include automatic running based on a browser and may realize web page automation. Based on native applications, web applications, and hybrid applications, automatic execution of automatic trigger control operations may be realized. The control type of operation may include user interface control, including view, label, text, link, text box, button, selection button, check box, drop-down menu, form, icon, etc. The operations may be click, double-click, slide, long-press, etc.

One or more embodiments of the above-mentioned technical solution is described in detail below in conjunction with several specific application scenes.

Scene 1: The playing of a network video may be recorded/played back on the same device.

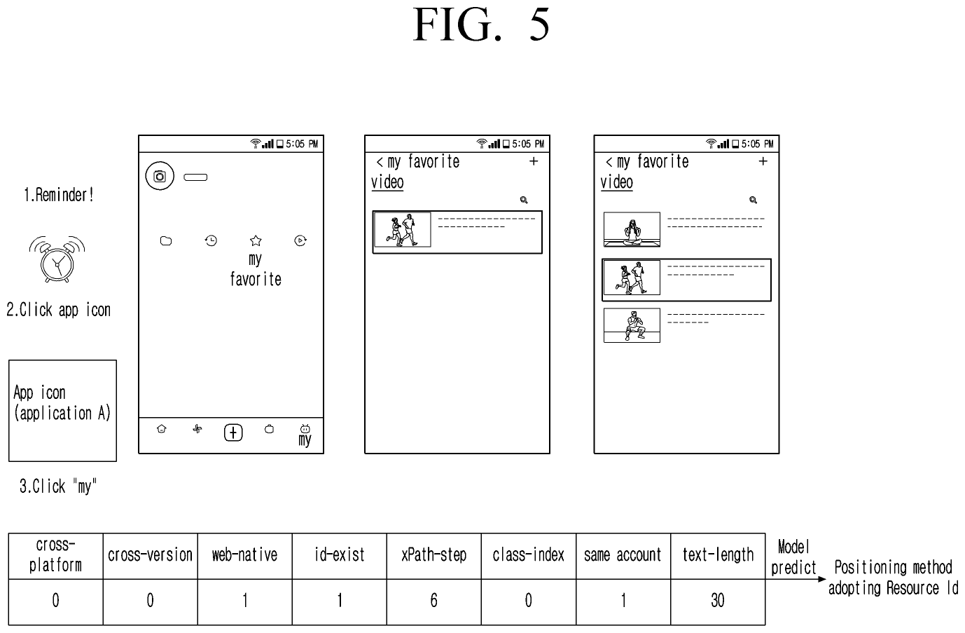

FIG. 5 is an exemplary diagram of a process of recording/playing back a playing network video on the same device. As shown in FIG. 5, a user A records a task of regularly playing a video in a network video application A using a mobile phone and replays a series of operations of “open my->enter my favorites->play a fitness video” at a time point set by an alarm every day. In this scene, a device, an application version of an app, and a logged-in user account may not change. However, since the user makes some personalized settings before operation playback, the page data content during operation recording may change during operation playback. As shown in FIG. 5, by collecting required environment data and control-related data at the time point of recording and playing back, a positioning feature may be extracted therefrom and inputted into a pre-trained positioning method prediction model to obtain that the predicted positioning method is a positioning method adopting Resource_Id. Based on the positioning method, the control may be positioned, and finally, a target control of the current operation may be obtained.

Scene 2: The playing of a network video is recorded/played back on different devices.

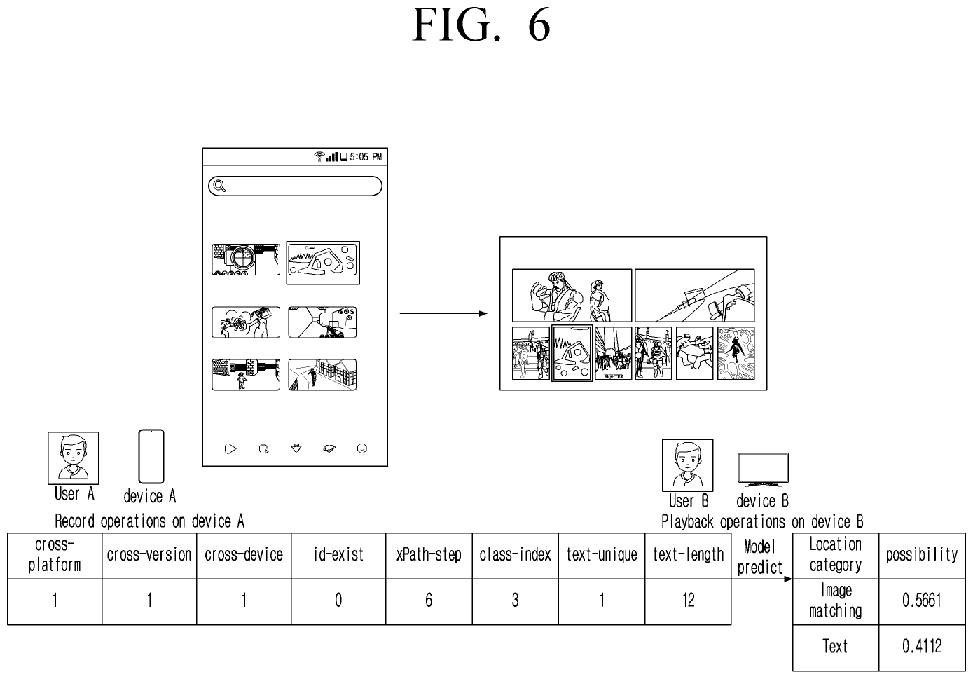

In scene 2, the user A uses a device A (an Android mobile phone) to record a series of operations using a video application. The details may include: “Open a home page->enter a child page->play intelligent garden of engineering vehicle in automobile world”, the user A remotely operates a device B (a television) of a user B and completes a series of operations of the above-mentioned recording on the same video application on the television. In the current scene, cross-device, cross-system platform, different application versions, and different page layouts occur when performing operation recording and playback. According to an embodiment of the present invention, required environment data may be collected on a recording device A and a playback device B, and after pre-processing the collected data, the environment data may be inputted into a trained positioning method prediction model to obtain the candidate positioning method. A first candidate positioning method may include an image matching positioning method, and a second candidate positioning method may include a text semantic matching positioning method. Therefore, the target control may be first positioned by adopting the image matching method, and if the positioning fails, the target control may be positioned by adopting the text semantic matching method. FIG. 6 is an exemplary diagram of an operation recording/playback process of scene 2. As shown in FIG. 6, in the operation playback process, the user selects a record according to the recorded operation record list and then clicks a playback button to enter a system device list selection interface. The user selects a device to be played back and clicks “start playback”, acquires environment data in which the playback is performed, and sequentially extracts record files. Positioning feature data constructed based on the environment data may be inputted into a positioning method prediction model, and predicted candidate positioning methods and respective probability values may be outputted. The target control may be positioned by successively adopting the predicted candidate positioning methods according to the probability values, judging whether all steps in the operation flow are completed after the target control is successfully positioned and the control is successfully operated, and if so, the playback operation may end and the result may return to the user interface.

Scene 3: The operation is recorded/played back on batch devices.

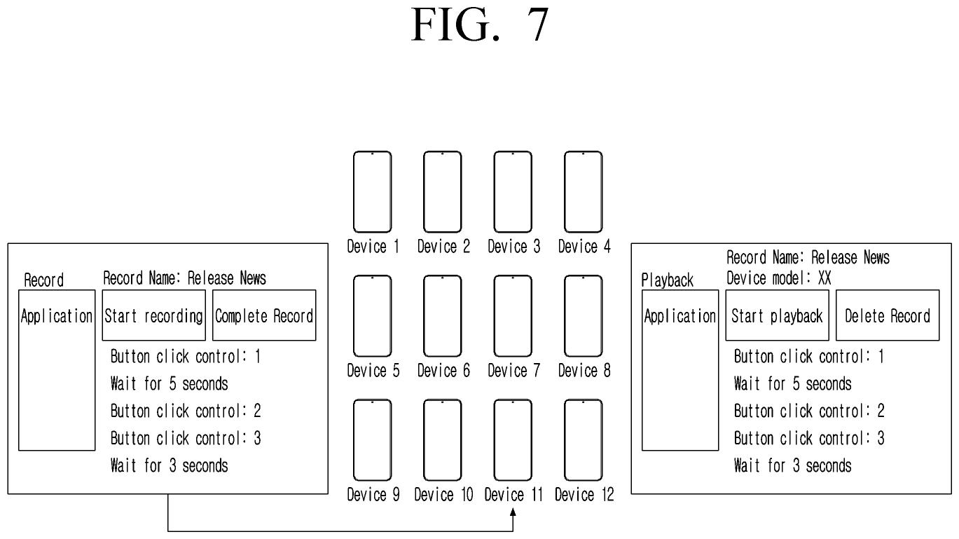

FIG. 7 is an exemplary diagram of an interface for recording/playing back the operation on batch devices in scene 3. In scene 3, in order to meet the needs of new media company operators to publish publicity content using multiple devices on each major platform app every day, company staff may use mobile apps to do batch operations, and thus mobile applications may run on multiple devices and multiple system platforms. As shown in FIG. 7, in this scene, the user may obtain a device state from a device management list, select a device from the device management list based on the device state, and may perform operation recording and playback by establishing a remote connection with the device. The user may view record information that completes recording from the operation record list, including number, name, number of steps, application name, recording device, etc. Each operation record may have corresponding script playback and deletion buttons so that the user triggers the playback and deletion of the record. When the user clicks a script playback button, a device list interface may jump to select a playback device. After a device is selected, a connection with the device may be triggered to perform operation playback in this device. In order to avoid the device performing playback being repeatedly selected, when a device is selected for operation playback, a corresponding button thereof may become an inactive state or prompt that the device is occupied.

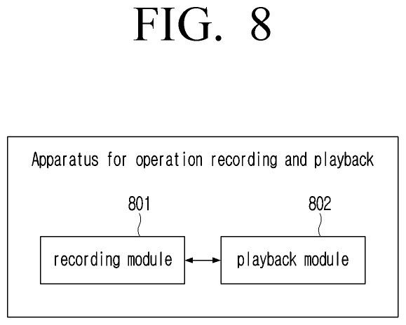

One or more embodiments may also propose an apparatus for operation recording and playback, as shown in FIG. 8, including:
a recording module 801, configured to record an operation of a user in a first device in response to an operation recording instruction to obtain a user operation record, and acquire respective environment data; and
a playback module 802, configured to perform user operations in the user operation record sequentially in response to an operation playback instruction, for each of the user operations, determining a corresponding target control in a second device based on the environment data and environment data of the second device currently performing operation playback, and performing a respective user operation based on the target control.

It should be noted that the above-mentioned method embodiments and apparatus embodiments are based on a same concept, and since the principles of the method and apparatus for solving the problems are similar, the implementation of the apparatus and method may be referred to each other, and the duplicated descriptions will be omitted.

According to an embodiment, an electronic device for operation recording and playback may include a processor and a memory. The memory may have stored therein an application program executable by the processor for causing the processor to perform the method for operation recording and playback as described above. A system or apparatus may be provided that is equipped with a storage medium on which a software program code that implements functions of any one of the implementations in the above-mentioned embodiments is stored, and causes a computer (or CPU or MPU) of the system or apparatus to read out and execute the program code stored in the storage medium. In addition, one or more embodiments may be executed by an operating system or the like operating on the computer through instructions based on the program code. The program code read from the storage medium may also be written into a memory provided in an expansion board inserted into the computer or a memory provided in an expansion unit connected to the computer, and then an instruction based on the program code may cause a CPU or the like installed on the expansion board or the expansion unit to perform some or all of the practical operations, thereby realizing the functions of any one of the above-mentioned methods for operation recording and playback implementations.

The memory may be implemented as various storage media such as an electrically erasable programmable read-only memory (EEPROM), a flash memory, and a programmable program read-only memory (PROM). The processor may be implemented to include one or more central processing units or one or more field programmable gate arrays, where the field programmable gate arrays integrate one or more central processing unit cores. The central processing unit or central processing unit core may be implemented as CPU or MCU.

One or more embodiments of the present application may implement a computer program product, including a computer program/instruction, and when executed by the processor, the computer program/instruction may implement the steps of the method for operation recording and playback as described above.

It should be noted that not all the steps and modules in the above-mentioned flowcharts and structure diagrams may be included, and some steps or modules may be omitted according to practical needs. An order in which each step is performed is not fixed and may be adjusted as desired. The division of various modules is merely to facilitate the description of the functional division adopted, and one module may be implemented by multiple modules, functions of multiple modules may also be implemented by a same module, and these modules may be positioned in a same device or different devices.

Hardware modules in the various implementations may be implemented mechanically or electronically. For example, one hardware module may include a specially designed permanent circuit or logic device (such as a dedicated processor, such as an FPGA or ASIC) for completing a particular operation. The hardware module may also include a programmable logic device or circuit (such as including a general purpose processor or other programmable processors) temporarily configured by software for performing a particular operation. Implementation of the hardware modules mechanically, adopting a dedicated permanent circuit, or adopting a temporarily configured circuit (such as configured by software) may be determined based on cost and time considerations.

Herein, “schematic” means “serving as an instance, example, or description”, and any illustration, implementation described herein as “schematic” should not be construed as a more preferred or advantageous technical solution. In order to make the drawings concise, only those parts of the drawings that are related to the present disclosure are schematically depicted, and may not be representative of a practical structure of the product. In addition, in order to make the drawings concise and easy to understand, only one of the components having a same structure or function in some of the drawings may be schematically depicted, or one of them may be marked. Herein, “a” does not mean to limit the number of relevant parts of the present invention to “only one”, and “a” does not mean to exclude the case that the number of relevant parts of the present invention is “more than one”. Herein, “upper”, “lower”, “front”, “back”, “left”, “right”, “inside”, “outside”, and the like are used merely to represent relative positional relationships between relevant parts and do not limit absolute positions of these relevant parts.

The solutions described in this disclosure, if involving personal information processing, will be processed on the premise of legality (for example, obtaining the consent of the personal information subject or being necessary for the performance of the contract), and will only be processed within the specified or agreed scope. The user may refuse to process personal information other than the necessary information required for basic functions without affecting the user's use of basic functions.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A method for recording and playback, comprising:
recording an operation of a user in a first device based on an operation recording instruction to obtain a user operation record;
acquiring environment data of the first device; and
performing user operations of the user operation record sequentially in a second device based on an operation playback instruction,
wherein the performing the user operations of the user operation record comprises, for one of the user operations:
determining a corresponding target control in the second device based on the environment data of the first device and environment data of the second device, and
performing a respective user operation based on the target control.

2. The method according to claim 1, wherein the environment data includes:
device-related data, application-related data, user-related data, or user operation-related data, and
wherein the user operation-related data includes:
a page screenshot, an XML layout file of a page, or a control screenshot of an operation object control.

3. The method according to claim 1, wherein the determining the corresponding target control in the second device based on the environment data of the first device and the environment data of the second device comprises:
extracting positioning feature data corresponding to an operation based on the environment data of the first device;
obtaining a prediction value of one or more positioning methods according to a positioning method prediction model based on the positioning feature data;
determining a candidate positioning method among the one or more positioning methods for positioning the target control in the second device according to the prediction value; and
determining the target control in the second device based on the candidate positioning method and the environment data of the first device.

4. The method according to claim 3, wherein the positioning feature data includes data based on:
whether a login user corresponding to the operation recording instruction and a login user corresponding to the operation playback instruction are the same,
whether a device corresponding to the operation recording instruction and a device corresponding to the operation playback instruction are the same,
whether an operating platform of the device corresponding to the operation recording instruction and an operating platform of the device corresponding to the operation playback instruction are the same,
whether an application corresponding to the operation recording instruction and an application corresponding to the operation playback instruction are the same,
whether a resource identification attribute of the target control is included in the environment data of the first device and the environment data of the second device,
an XPath path positioning step number of the target control in the environment data of the first device,
whether the target control has a different text string in the first device and the second device,
a text string attribute length of the target control in the first device,
an index value of a control type of the target control in the first device,
an interface content similarity between the first device and the second device,
a page similarity between the first device and the second device, or
an interface style similarity between the first device and the second device.

5. The method according to claim 3, wherein the one or more positioning methods include:
a control attribute-based positioning method, or an interface matching method, and
wherein the interface matching method includes:
an image matching positioning method or a layout matching positioning method.

6. The method according to claim 3, wherein the determining the candidate positioning method comprises:
screening out a positioning method based on the prediction value being greater than a pre-set threshold value from the one or more positioning methods to obtain the candidate positioning method; or
ordering the one or more positioning methods in an order based on respective prediction values, and selecting a number of positioning methods from the order as the candidate positioning method, and
wherein the number of positioning methods is a pre-set number of candidate positioning methods.

7. The method according to claim 3, wherein the determining the target control in the second device based on the candidate positioning method and the environment data of the first device comprises:
traversing the candidate positioning method according to an order of respective prediction values; and
determining the target control of a current operation according to the candidate positioning method based on the environment data of the first device until the target control is determined or the traversing is completed.

8. An electronic device comprising a processor and a memory,
the memory storing an application program executable by the processor for causing the processor to perform:
recording an operation of a user in a first device based on an operation recording instruction to obtain a user operation record;
acquiring environment data of the first device; and
performing user operations of the user operation record sequentially in a second device based on an operation playback instruction,
wherein the performing the user operations of the user operation record includes, for one of the user operations:
determining a corresponding target control in the second device based on the environment data of the first device and environment data of the second device, and
performing a respective user operation based on the target control.

9. An electronic device according to claim 8, wherein the environment data comprises:
device-related data, application-related data, user-related data, or user operation-related data,
wherein the user operation-related data comprises:
a page screenshot, an XML layout file of a page, or a control screenshot of an operation object control.

10. An electronic device according to claim 8, wherein the determining the corresponding target control in the second device based on the environment data of the first device and the environment data of the second device includes:
extracting positioning feature data corresponding to an operation based on the environment data of the first device;
obtaining a prediction value of one or more positioning methods according to a positioning method prediction model based on the positioning feature data;
determining a candidate positioning method among the one or more positioning methods for positioning the target control in the second device according to the prediction value; and
determining the target control in the second device based on the candidate positioning method and the environment data of the first device.

11. An electronic device according to claim 10, wherein the positioning feature data comprises data based on:
whether a login user corresponding to the operation recording instruction and a login user corresponding to the operation playback instruction are the same,
whether a device corresponding to the operation recording instruction and a device corresponding to the operation playback instruction are the same,
whether an operating platform of the device corresponding to the operation recording instruction and an operating platform of the device corresponding to the operation playback instruction are the same,
whether an application corresponding to the operation recording instruction and an application corresponding to the operation playback instruction are the same,
whether a resource identification attribute of the target control is included in the environment data of the first device and the environment data of the second device,
an XPath path positioning step number of the target control in the environment data of the first device,
whether the target control has a different text string in the first device and the second device,
a text string attribute length of the target control in the first device,
an index value of a control type of the target control in the first device,
an interface content similarity between the first device and the second device,
a page similarity between the first device and the second device, or
an interface style similarity between the first device and the second device.

12. An electronic device according to claim 10, wherein the one or more positioning methods comprise:
a control attribute-based positioning method or an interface matching method,
wherein the interface matching method comprises:
an image matching positioning method or a layout matching positioning method.

13. An electronic device according to claim 10, wherein the determining the candidate positioning method includes:
screening out a positioning method based on the prediction value being greater than a pre-set threshold value from the one or more positioning methods to obtain the candidate positioning method; or
ordering the one or more positioning methods in an order based on respective prediction values, and selecting a number of positioning methods from the order as the candidate positioning method,
wherein the number of positioning methods is a pre-set number of candidate positioning methods.

14. An electronic device according to claim 10, wherein the determining the target control in the second device based on the candidate positioning method and the environment data of the first device includes:
traversing the candidate positioning method according to an order of respective prediction values; and
determining the target control of a current operation according to the candidate positioning method based on the environment data of the first device until the target control is determined or the traversing is completed.

15. A non-transitory machine-readable medium comprising instructions that when executed cause at least one processor of an electronic device to:
record an operation of a first device based on an operation recording instruction to obtain a user operation record;
acquire environment data of the first device; and
perform user operations of the user operation record sequentially in a second device based on an operation playback instruction,
wherein performing the user operations comprises, for one of the user operations:
determining a corresponding target control in the second device based on the environment data of the first device and environment data of the second device, and
performing a respective user operation based on the target control.
